(19) United States
(12) Patent Application Publication
(10) Pub. No.: US 2019/0225155 A1
(43) Pub. Date: Jul. 25, 2019

(54) VIEWING DEVICE FOR VEHICLE

(71) Applicant: KABUSHIKI KAISHA TOKAI-RIKA-DENKI-SEISAKUSHO, Aichi (JP)

(72) Inventors: Suguru FUJISAKI, Aichi (JP); Shigeki YOSHIDA, Aichi (JP)

(21) Appl. No.: 16/333,052

(22) PCT Filed: Aug. 30, 2017
(86) PCT No.: PCT/JP2017/031254

§ 371 Date: Mar. 13, 2019

(30) Foreign Application Priority Data
Sep. 20, 2016 (JP) 2016-183429

(51) Int. Cl. B60R 1/072

(52) U.S. Cl. CPC B60R 1/072

(57) ABSTRACT

At a door mirror device for a vehicle, limiting plates of a visor body are inserted in limiting holes of a reinforcement, and engaging claws of the limiting plates are engaged with the limiting holes, and the reinforcement is held at the visor body. Therefore, before the reinforcement is assembled to the visor body, the limiting plates are inserted in the limiting holes, and the engaging claws are engaged with the limiting holes, and, due thereto, the reinforcement can be held at the visor body.

### TECHNICAL FIELD

The present invention relates to a viewing device for a vehicle at which a viewing mechanism assists viewing by an occupant of a vehicle.

### BACKGROUND ART

In the electric door mirror disclosed in Japanese Patent Application Laid-Open (JP-A) No. 2013-67194, the motor and the like of a mirror surface angle adjusting unit are covered by a motor holder and an inner member.

Here, at this electric door mirror, it is preferable for the inner member to be held at the motor holder, before the motor holder and the inner member are assembled by the fastening of screws.

### SUMMARY OF INVENTION

### Technical Problem

In view of the above-described circumstances, an object of the present invention is to provide a viewing device for a vehicle that can hold a covering member.

### Solution to Problem

A viewing device for a vehicle of a first aspect of the present invention, the viewing device comprises: a viewing mechanism that assists viewing by an occupant of a vehicle; an operating mechanism that, by being operated, the viewing mechanism is tilted; a covering member that covers the operating mechanism; and an engaging claw that, by being engaged, the covering member is held.

A viewing device for a vehicle of a second aspect of the present invention comprises, in the viewing device for a vehicle of the first aspect of the present invention: a terminal that is provided at the covering member, that is connected to the operating mechanism, and that supplies electric power; and a guiding portion at which the engaging claw is provided, and that guides connecting of the terminal to the operating mechanism.

In a viewing device for a vehicle of a third aspect of the present invention, in the viewing device for a vehicle of the second aspect of the present invention, the guiding portion guides the connecting of the terminal to the operating mechanism in a periphery of the engaging claw.

In a viewing device for a vehicle of a fourth aspect of the present invention, in the viewing device for a vehicle of the second aspect or the third aspect of the present invention, the engaging claw, by an urging force, causes the guiding portion and the covering member to contact one another.

In a viewing device for a vehicle of a fifth aspect of the present invention, in the viewing device for a vehicle of any one of the first aspect through the fourth aspect of the present invention, the engaging claw limits movement of the covering member, the movement being due to a load applied from the operating mechanism.

In a viewing device for a vehicle of a sixth aspect of the present invention, in the viewing device for a vehicle of the fifth aspect of the present invention, a plurality of the engaging claws are provided at a periphery of a region of the covering member to which a load is applied from the viewing mechanism via the operating mechanism.

In a viewing device for a vehicle of a seventh aspect of the present invention, in the viewing device for a vehicle of any one of the first aspect through the sixth aspect of the present invention, the engaging claw urges the covering member in an extending direction.

### Advantageous Effects of Invention

In the viewing device for a vehicle of the first aspect of the present invention, the viewing mechanism assists viewing by an occupant of the vehicle. Moreover, the viewing mechanism is tilted due to the operating mechanism being operated. Further, the covering member covers the operating mechanism.

Here, the covering member is held due to the engaging claw being engaged. Therefore, the covering member can be held.

In the viewing device for a vehicle of the second aspect of the present invention, the terminal of the covering member is connected to the operating mechanism and supplies electric power. Further, the guiding portion guides the connecting of the terminal to the operating mechanism.

Here, the engaging claw is provided at the guiding portion. Therefore, the guiding portion can appropriately guide the engaging of the engaging claw.

In the viewing device for a vehicle of the third aspect of the present invention, the guiding portion guides the connecting of the terminal to the operating mechanism, in the periphery of the engaging claw. Therefore, the guiding portion can appropriately guide the connecting of the terminal to the operating mechanism.

In the viewing device for a vehicle of the fourth aspect of the present invention, by the urging force, the engaging claw causes the guiding portion and the covering member to contact one another. Therefore, the held position of the covering member can be achieved appropriately.

In the viewing device for a vehicle of the fifth aspect of the present invention, the engaging claw limits the movement of the covering member which is due to the load applied from the operating mechanism. Therefore, the covering member can support the operating mechanism well.

In the viewing device for a vehicle of the sixth aspect of the present invention, the plural engaging claws are provided at the periphery of the region of the covering member to which the load is applied from the viewing mechanism via the operating mechanism. Therefore, the covering member can effectively support the operating mechanism.

In the viewing device for a vehicle of the seventh aspect of the present invention, the engaging claw urges the covering member in the extending direction. Therefore, the force of holding the covering member can be increased effectively.

### BRIEF DESCRIPTION OF DRAWINGS

FIG. 1 is an exploded perspective view that is seen from a vehicle front side and a vehicle transverse direction inner side and shows a door mirror device for a vehicle relating to an embodiment of the present invention.

FIG. 2 is a cross-sectional view that is seen from a vehicle transverse direction outer side and shows main portions of the door mirror device for a vehicle relating to the embodiment of the present invention.

FIG. 3 is a perspective view that is seen from a vehicle rear side and the vehicle transverse direction inner side and shows a visor body of the door mirror device for a vehicle relating to the embodiment of the present invention.

FIG. 4 is an exploded perspective view that is seen from the vehicle front side and a lower side and shows the visor body and a reinforcement and the like of the door mirror device for a vehicle relating to the embodiment of the present invention.

FIG. 5 is a front view that is seen from the vehicle front side and shows the visor body and the reinforcement and the like of the door mirror device for a vehicle relating to the embodiment of the present invention.

FIG. 6A is a perspective view that shows a limiting plate and the like of the visor body at the door mirror device for a vehicle relating to the embodiment of the present invention.

FIG. 6B is a cross-sectional view that shows a limiting plate and the like of the visor body at the door mirror device for a vehicle relating to the embodiment of the present invention.

### DESCRIPTION OF EMBODIMENTS

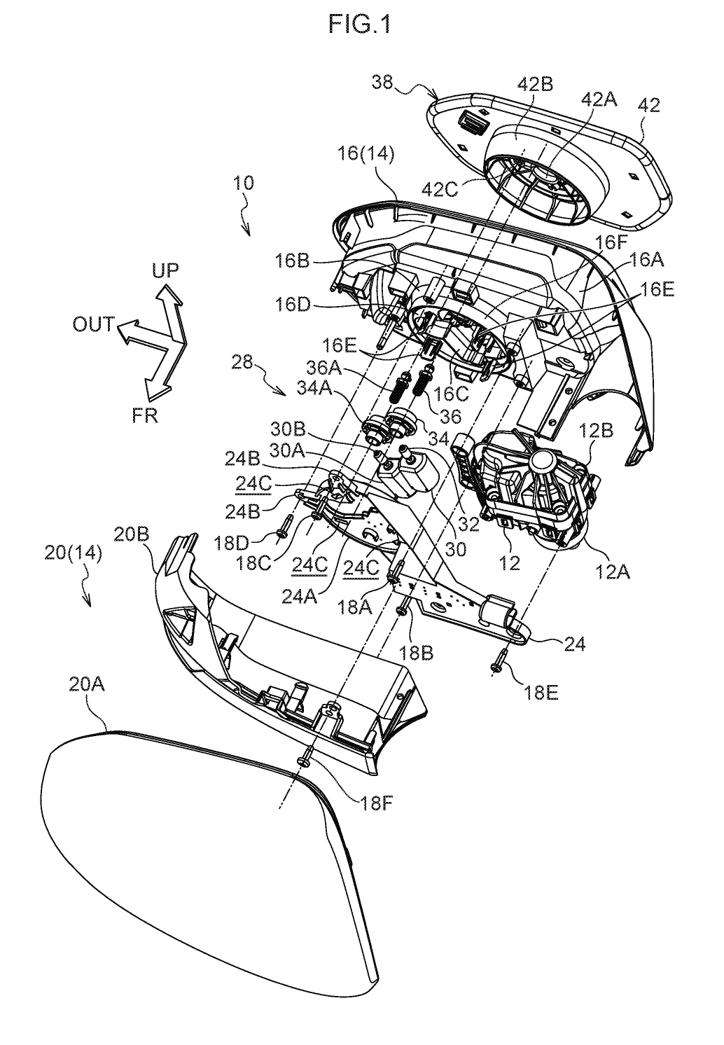

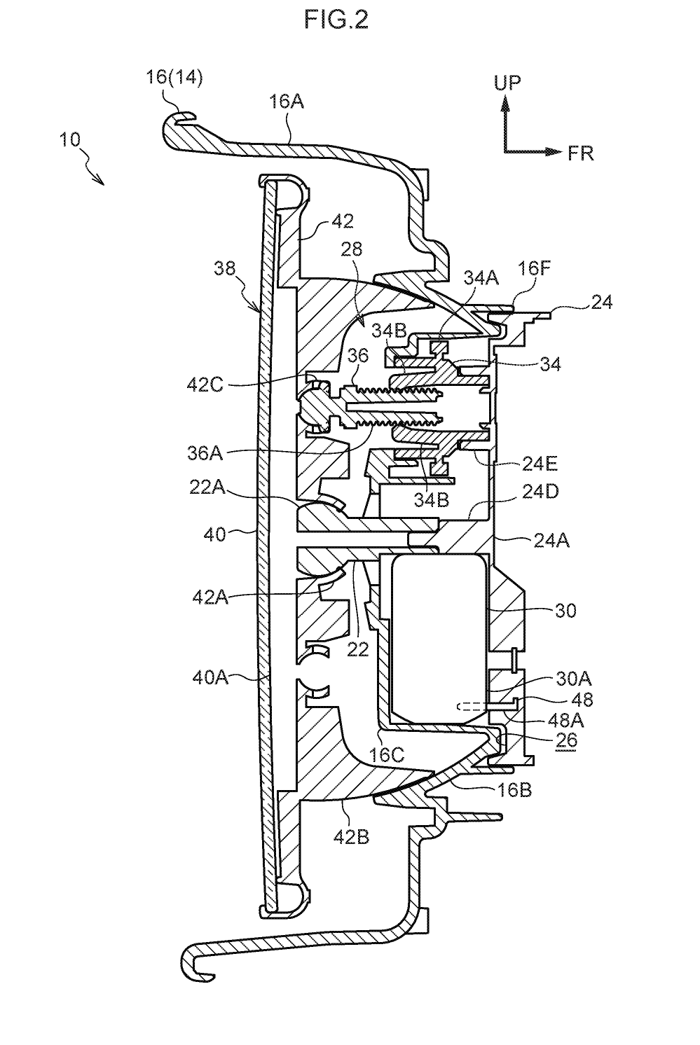

A door mirror device 10 for a vehicle, which serves as a viewing device for a vehicle and relates to an embodiment of the present invention, is shown in FIG. 1 in an exploded perspective view seen from a vehicle front side and a vehicle transverse direction inner side (the vehicle left side). Main portions of the door mirror device 10 for a vehicle are shown in FIG. 2 in a cross-sectional view that is seen from a vehicle transverse direction outer side (the vehicle right side). Note that, in the drawings, the vehicle forward side is indicated by arrow FR, the vehicle transverse direction outer side is indicated by arrow OUT, and the upper side is indicated by arrow UP.

The door mirror device 10 for a vehicle relating to the present embodiment is supported at the outer side of a door (a front side door, the vehicle body side) of a vehicle.

As shown in FIG. 1, the door mirror device 10 for a vehicle has a retracting mechanism 12. A stand 12A that serves as a supporting member is provided at the retracting mechanism 12. The door mirror device 10 for a vehicle is supported at the door due to the stand 12A being supported at the vehicle front side end of the vertical direction intermediate portion of the door. A rotating body 12B is supported at the stand 12A. Due to the retracting mechanism 12 being operated electrically, the rotating body 12B is rotated around the vertical direction with respect to the stand 12A. The rotating body 12B is electrically connected to a control device (not illustrated) at the vehicle body side, and the retracting mechanism 12 is electrically operated by control of the control device.

A visor 14, which is made of resin and serves as an outer peripheral body, is supported at the rotating body 12B of the retracting mechanism 12. A visor body 16 that serves as an accommodating body (engaging member) is provided at the visor 14. The rotating body 12B is fixed to the vehicle front side of the vehicle transverse direction inner side end portion of the visor body 16 by the fastening of a first screw 18A and a second screw 18B that serve as assembly members, and the like. A visor cover 20, which is shaped as a curved plate and serves as a covering member, is assembled to the vehicle front side of the visor body 16 via a reinforcement 24 that is described later. The outer periphery of the visor cover 20 is fit-together with the outer periphery of the visor body 16, and the visor cover 20 covers the vehicle front side of the visor body 16. An upper cover 20A at the upper side and a lower cover 20B at the lower side are provided at the visor cover 20. The visor cover 20 is structured due to the upper cover 20A and the lower cover 20B being combined.

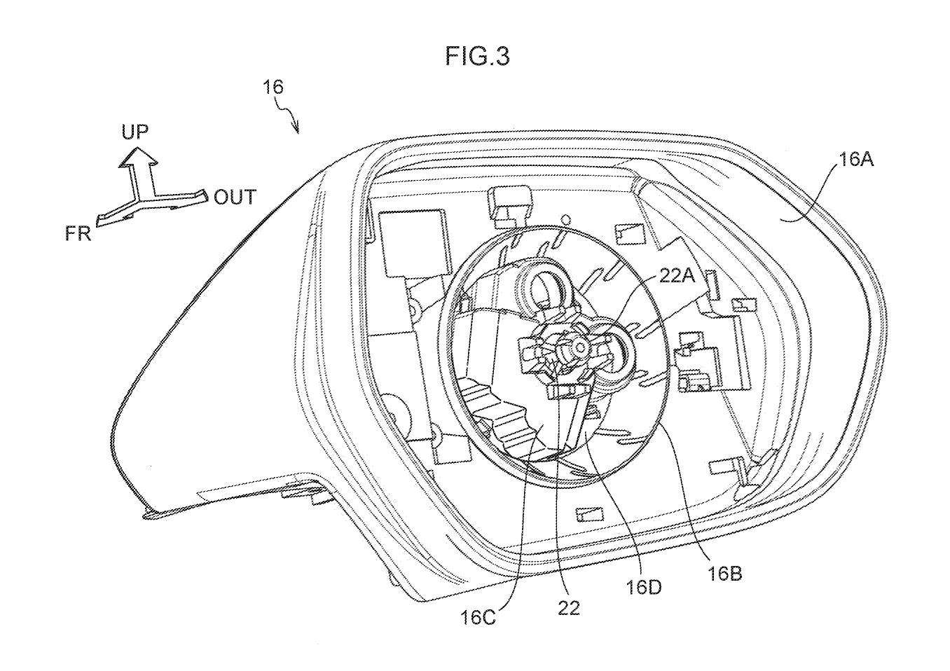

As shown in FIG. 1 through FIG. 3, an accommodating wall 16A, which is substantially shaped as a rectangular parallelepiped box and serves as an accommodating portion, is provided at the visor body 16. The interior of the accommodating wall 16A opens to the vehicle rear side.

A supporting wall 16B (case lower portion) that serves as a supporting portion is provided integrally with the vehicle front side wall (the bottom wall) of the accommodating wall 16A. The supporting wall 16B projects out toward the vehicle front side and the vehicle rear side of the vehicle front side wall of the accommodating wall 16A. The supporting wall 16B is substantially tubular, and the central axis of the supporting wall 16B is disposed parallel to the vehicle longitudinal direction. The supporting wall 16B is shaped as a spherical wall, and the inner diameter dimension of the supporting wall 16B gradually increases toward the vehicle rear side.

A covering wall 16C (case upper portion), which is shaped as a container and serves as a covering portion, is provided at the interior of the supporting wall 16B. The entire periphery at the vehicle front side end of the covering wall 16C is made integral with the entire periphery of the vehicle front side end of the supporting wall 16B. A connecting wall 16D that is flat-plate-shaped is provided integrally between the vehicle front side end of the covering wall 16C and the vehicle front side end of the supporting wall 16B. At the portion where the vehicle front side end of the covering wall 16C and the vehicle front side end of the supporting wall 16B are not directly made integral, the connecting wall 16D connects the vehicle front side end of the covering wall 16C and the vehicle front side end of the supporting wall 16B. The interior of the covering wall 16C opens toward the vehicle front side of the supporting wall 16B, and, due thereto, the interior of the covering wall 16C opens toward the vehicle front side of the accommodating wall 16A.

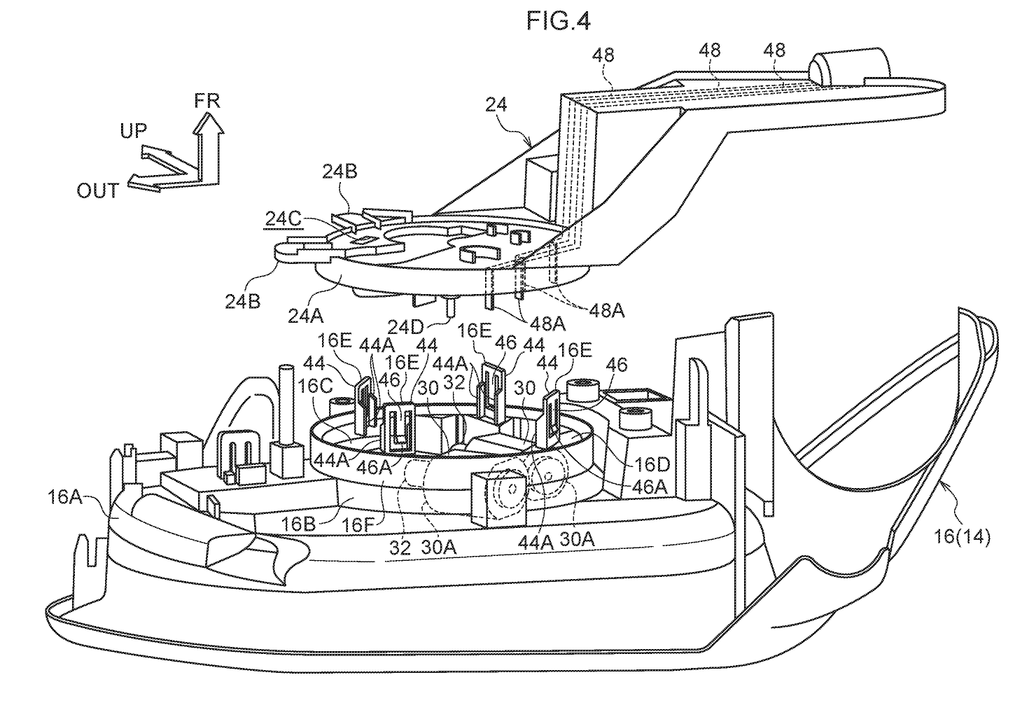

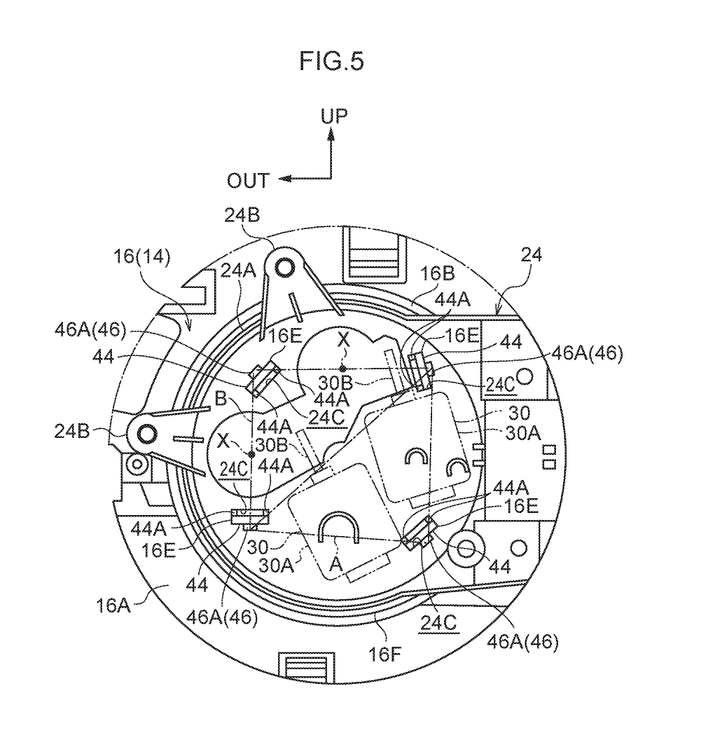

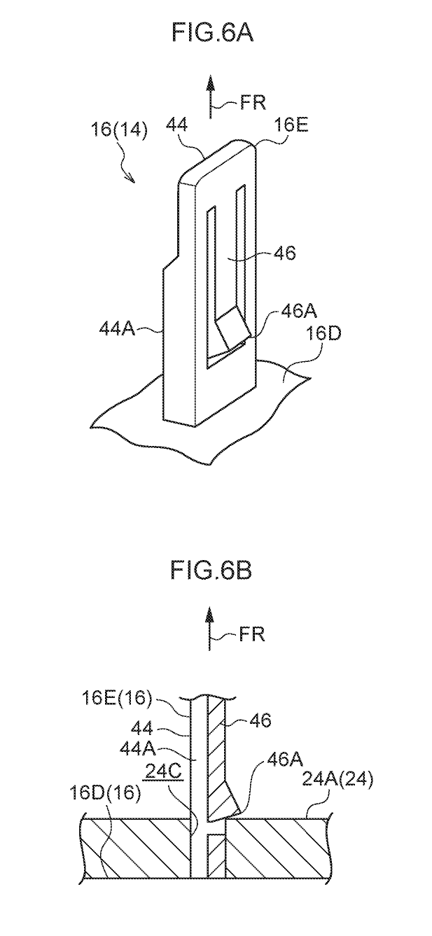

A predetermined number (four in the present embodiment) of limiting plates 16E (see FIG. 4, FIG. 5, FIG. 6A and FIG. 6B), which are shaped as rectangular plates and serve as limiting portions, are provided integrally with the connecting wall 16D. The limiting plates 16E project out toward the vehicle front side from the connecting wall 16D. The predetermined number of limiting plates 16E are disposed at a substantially uniform interval in the peripheral direction of the supporting wall 16B, and the limiting plates 16E are disposed so as to intersect the radial direction of the supporting wall 16B. Further, in the present embodiment, the limiting plates 16E are disposed at the vehicle transverse direction both outer sides of the upper portion and the lower portion of the covering wall 16C.

A guide plate 44, which is shaped as a substantially U-shaped plate and serves as a guiding portion, is provided at the limiting plate 16E. The guide plate 44 is made integral with the connecting wall 16D at the end portion that is at the open side (the vehicle rear side) of the interior. Projecting portions 44A that are shaped as elongated plates are formed at the supporting wall 16B radial direction inner side surface of the guide plate 44, at the vehicle rear side portions of the transverse direction (the direction orthogonal to the vehicle longitudinal direction) both end portions. The projecting portions 44A project out orthogonally to the guide plate 44. The projecting portions 44A are extended in the vehicle longitudinal direction. The vehicle front side end surfaces of the projecting portions 44A are inclined in directions toward the side opposite from the guide plate 44 while heading toward the vehicle rear side.

An engaging claw 46, which is substantially shaped as an elongated plate, is provided within the guide plate 44. The engaging claw 46 is extended in the vehicle longitudinal direction, and the vehicle front side end thereof is made integral with the vehicle front side end portion of the guide plate 44. A convex portion 46A, which is triangular in cross-section and serves as an engaging portion, is formed at the vehicle rear side end portion of the engaging claw 46. The convex portion 46A projects out toward the side opposite from the projecting portions 44A (the radial direction outer side of the supporting wall 16B), and the vehicle rear side surface thereof is inclined in the direction toward the engaging claw 46 side while heading toward the vehicle rear side.

A fit-together tube 16F, which is shaped as a cylindrical tube and serves as a fit-together portion, is provided integrally with the outer peripheral surface of the supporting wall 16B at the vehicle longitudinal direction intermediate portion. The fit-together tube 16F projects out toward the vehicle front side from the supporting wall 16B, and is disposed coaxially with the supporting wall 16B.

A holding tube 22, which is substantially shaped as a cylindrical tube and serves as a holding portion, is provided integrally with the vehicle rear side wall (the bottom wall) of the covering wall 16C. The holding tube 22 projects out toward the vehicle front side and the vehicle rear side of the vehicle rear side wall of the covering wall 16C, and is disposed coaxially with the supporting wall 16B. A holding sphere 22A that is substantially spherical is provided at the vehicle rear side end portion of the holding tube 22. The peripheral surfaces at the vehicle front side portion and the vehicle rear side portion of the holding sphere 22A are shaped as spherical surfaces, and the centers of those peripheral coincide with the center of the inner peripheral surface of the supporting wall 16B.

The reinforcement 24 (rigidity member), which is substantially made of resin and is shaped as an elongated plate and serves as a reinforcing body (covering member), is provided at the vehicle front sides of the visor body 16 and the rotating body 12B of the retracting mechanism 12. The vehicle transverse direction intermediate portion of the reinforcement 24 is fixed, together with the rotating body 12B, to the visor body 16 by the fastening of the first screw 18A and the second screw 18B.

A pair of assembly plates 24B, which are shaped as triangular plates and serve as assembly portions, are provided integrally with the vehicle transverse direction outer side portion of the reinforcement 24. The pair of assembly plates 24B respectively project out toward the upper side and the vehicle transverse direction outer side from the reinforcement 24. The vehicle transverse direction outer side portion of the reinforcement 24 is, at the pair of assembly plates 24B, fixed to the visor body 16 by the fastening of a third screw 18C and a fourth screw 18D that serve as assembly members, respectively. The vehicle transverse direction inner side end portion of the reinforcement 24 is fixed to the rotating body 12B by the fastening of a fifth screw 18E that serves as an assembly member.

The rigidity of the reinforcement 24 is made to be high as compared with the visor body 16, and the reinforcement 24 reinforces the visor body 16 and the rotating body 12B. Further, the visor cover 20 (the lower cover 20B) of the visor 14 is fixed to the reinforcement 24 by the fastening of a sixth screw 18F that serves as a fixing member. Due thereto, the visor cover 20 is assembled to the visor body 16 via the reinforcement 24 as described above.

A bottom wall portion 24A, which is disc-shaped and serves as a closing-off portion, is provided at the vehicle transverse direction outer side portion of the reinforcement 24. A concave portion 26, which is rectangular in cross-section and serves as an insertion portion, is formed at the outer peripheral portion of the vehicle rear side surface of the bottom wall portion 24A, at the entire periphery thereof. The bottom wall portion 24A is fit-together within the fit-together tube 16F of the visor body 16, and the vehicle front side end of the supporting wall 16B of the visor body 16 is inserted in the concave portion 26, and the outer peripheral surface of the supporting wall 16B is fit-together with the outer peripheral surface of the concave portion 26. Due thereto, the bottom wall portion 24A covers and closes-off the vehicle front sides of the supporting wall 16B and the covering wall 16C of the visor body 16.

A predetermined number (four in the present embodiment) of limiting holes 24C (see FIG. 4, FIG. 5 and FIG. 6B), which are rectangular and serve as limited portions (engaged portions and guided portions), are formed in the bottom wall portion 24A so as to pass therethrough. The predetermined number of limiting holes 24C are disposed at a substantially uniform interval in the peripheral direction of the bottom wall portion 24A, and are respectively disposed so as to intersect the radial direction of the bottom wall portion 24A. Further, in the present embodiment, the limiting holes 24C are disposed at the vehicle transverse direction both side portions of the upper portion and the lower portion of the bottom wall portion 24A.

The limiting plates 16E of the visor body 16 are inserted into the limiting holes 24C, and the guide plates 44 (including the pairs of projecting portions 44A) of the limiting plates 16E are fit-together with the limiting holes 24C in the length directions and the width directions. Therefore, the limiting plates 16E limit movement of the limiting holes 24C in the length directions and the width directions, and movement in the peripheral direction and the radial direction of the bottom wall portion 24A is limited. The vehicle rear side surfaces of the convex portions 46A of the engaging claws 46 of the limiting plates 16E are engaged with (abut) the corner portions, which are at the bottom wall portion 24A radial direction outer sides and the vehicle front sides, of the limiting holes 24C. The engaging claws 46 (including the convex portions 46A) urge the bottom wall portion 24A toward the vehicle rear side (the extending direction of the engaging claws 46), and limit movement of the bottom wall portion 24A toward the vehicle front side, and urge the bottom wall portion 24A toward the radial direction outer side, and cause the pairs of projecting portions 44A of the guide plates 44 to press-contact the bottom wall portion 24A radial direction inner side surfaces of the limiting holes 24C.

A fit-in pillar 24D, which is substantially solid cylindrical and serves as a fit-in portion, is provided integrally with the central portion of the bottom wall portion 24A. The fit-in pillar 24D projects out toward the vehicle rear side from the bottom wall portion 24A, and is disposed coaxially with the bottom wall portion 24A. The diameter of the distal end portion of the fit-in pillar 24D is narrowed, and the distal end portion of the fit-in pillar 24D is fit into the holding tube 22 of the visor body 16 from the vehicle front side.

A supporting tube 24E that is shaped as a cylindrical tube is provided integrally with the upper portion and the vehicle transverse direction outer side portion of the bottom wall portion 24A, at the bottom wall portion 24A radial direction inner side of the assembly plates 24B. The supporting tube 24E projects out toward the vehicle rear side from the bottom wall portion 24A, and the central axis of the supporting tube 24E is disposed parallel to the central axis of the bottom wall portion 24A.

Plural wires 48 (see FIG. 4), which are shaped as elongated plates, are provided within the reinforcement 24 by insert molding. The proximal end sides of the plural wires 48 are electrically connected to the control device. Two pairs of terminals 48A (see FIG. 4), which are shaped as elongated plates, are provided at the reinforcement 24 by insert molding. The proximal ends of the terminals 48A are made integral with the distal end sides of the wires 48, and the proximal end portions of the terminals 48A are fixed to the reinforcement 24 interior, and the terminals 48A extend out from the reinforcement 24 toward the vehicle rear side. The vehicle longitudinal direction positions of the respective terminals 48A coincide, and each of the pairs of terminals 48A respectively are disposed parallel to one another, and face one another in a state of being apart from one another in the wall thickness direction (the direction orthogonal to the vehicle longitudinal direction).

A mirror surface adjusting mechanism 28 that serves as an operating mechanism is held between the covering wall 16C of the visor body 16 and the bottom wall portion 24A of the reinforcement 24.

A pair of motors 30 (see FIG. 4 and FIG. 5) that serve as driving mechanisms are provided at the mirror surface adjusting mechanism 28. A main body portion 30A of the motor 30 is held in a state of being nipped between the covering wall 16C and the bottom wall portion 24A. An output shaft 30B extends out from the distal end (the upper side end) of the main body portion 30A, and a worm 32 that serves as an outputting member is fixed to the output shaft 30B. A pair of the terminals 48A of the reinforcement 24 are inserted in the proximal end portion (the lower side end portion) of the main body portion 30A, and the main body portion 30A is electrically connected to the control device via the pair of terminals 48A and the wires 48 of the reinforcement 24. Therefore, the mirror surface adjusting mechanism 28 is electrically operated due to electric power being supplied to the motor 30 and the motor 30 being driven by control of the control device.

A pair of wheel drives 34, which are substantially cylindrical tube shaped and are made of resin and serve as transmitting members, are provided at the mirror surface adjusting mechanism 28. The wheel drives 34 are nipped between the covering wall 16C and the bottom wall portion 24A in a state of the vehicle front side portions of the wheel drives 34 being fit-into the supporting tube 24E of the bottom wall portion 24A, and are held so as to rotate freely around the axes thereof.

A worm wheel 34A is formed coaxially at the outer peripheral portion of the wheel drive 34, at the axial direction (vehicle longitudinal direction) intermediate portion thereof. The worm wheel 34A meshes-together with (is engaged with) the worm 32 of the motor 30. Therefore, due to the motor 30 being driven and the worm 32 being rotated integrally with the output shaft 30B of the motor 30, the worm wheel 34A is rotated, and the wheel drive 34 is rotated.

A predetermined number (four in the present embodiment) of meshing claws 34B that serve as engaging portions are formed at the inner peripheral portion of the wheel drive 34 at the vehicle rear side of the worm wheel 34A. The predetermined number of meshing claws 34B are disposed at a uniform interval in the peripheral direction of the wheel drive 34. The meshing claws 34B extend out toward the vehicle rear side, and are elastic. The distal ends (the vehicle rear side ends) of the meshing claws 34B project out toward the radial direction inner side of the wheel drive 34.

Rod drives 36, which are substantially shaped as solid cylinders and serve as moving members, are coaxially inserted within the wheel drives 34. The rod drives 36 project out toward the vehicle rear side from the covering wall 16C. The one rod drive 36 is disposed above (or may be disposed beneath) the central axis of the supporting wall 16B of the visor body 16, and the other rod drive 36 is disposed at the vehicle transverse direction outer side (or may be disposed at the vehicle transverse direction inner side) of the central axis of the supporting wall 16B.

The portions, which are other than the distal end portions (the vehicle rear side end portions), of the rod drives 36 are made to be screws 36A. The distal ends of the meshing claws 34B of the wheel drives 34 are meshed-together with (engaged with) the screws 36A. Further, the distal end portions of the rod drives 36 are formed in substantially spherical shapes.

A mirror body 38 that serves as a viewing mechanism is accommodated within the accommodating wall 16A of the visor body 16. The entire periphery of and the vehicle front side of the mirror body 38 are covered by the accommodating wall 16A.

A mirror 40, which is substantially shaped as a rectangular plate and serves as a viewing portion, is provided at the vehicle rear side portion of the mirror body 38. The obverse of the mirror 40 is exposed at the vehicle rear side of the visor body 16. A mirror surface 40A (the obverse of the reflecting layer at the reverse side) of the mirror 40 faces the vehicle rear side, and viewing of the vehicle rear side by an occupant of the vehicle (the driver in particular) is assisted by the mirror 40.

A mirror holder 42, which is substantially shaped as a rectangular plate and is made of resin and serves as a sliding body, is provided at the vehicle front side portion of the mirror body 38. The entire periphery of the mirror 40 is fixed to (held at) the entire periphery of the mirror holder 42, and the mirror holder 42 covers the vehicle front side (the reverse side) of the mirror 40.

A mounting wall 42A, which is substantially tubular and serves as a mounting portion, is formed at the mirror holder 42 at the vehicle front side of the central position (the center of gravity position) of the mirror 40. The mounting wall 42A is disposed coaxially with the supporting wall 16B of the visor body 16. The mounting wall 42A is substantially shaped as a spherical wall, and the inner diameter dimension of the mounting wall 42A gradually becomes larger toward the vehicle rear side. The holding sphere 22A of the holding tube 22 of the visor body 16 is fit into the mounting wall 42A. Due thereto, the mirror body 38 is held at the holding tube 22 so as to be able to tilt and so as to be able to slide.

A sliding wall 42B, which is substantially tubular and serves as a sliding portion, is provided integrally with the vehicle front side of the mirror holder 42. The sliding wall 42B is disposed coaxially with the supporting wall 16B of the visor body 16. The sliding wall 42B is shaped as a spherical wall, and the outer diameter dimension of the sliding wall 42B gradually becomes larger toward the vehicle rear side. The outer peripheral surface of the sliding wall 42B abuts the inner peripheral surface of the supporting wall 16B, and the sliding wall 42B is supported at the supporting wall 16B so as to be able to tilt and so as to be able to slide.

A pair of rotating walls 42C, which are substantially tubular and serve as rotating portions, are formed at the mirror holder 42 at the radial direction inner side of the sliding wall 42B. One of the rotating walls 42C is disposed at the upper side (or may be disposed at the lower side) of the central axis of the supporting wall 16B of the visor body 16. The other rotating wall 42C is disposed at the vehicle transverse direction outer side (or may be disposed at the vehicle transverse direction inner side) of the central axis of the supporting wall 16B. The central axes of the rotating walls 42C are disposed parallel to the central axis of the supporting wall 16B of the visor body 16, and the rotating walls 42C are substantially shaped as spherical walls. The inner diameter dimensions of the rotating walls 42C gradually become larger from the vehicle longitudinal direction both end sides toward the vehicle longitudinal direction central sides thereof.

The distal end portions of the rod drives 36 at the mirror surface adjusting mechanism 28 are fit into and held at the interiors of the rotating walls 42C. Rotation of the rotating walls 42C with respect to the distal end portions of the rod drives 36 is permitted, and rotation around the axes of the rod drives 36 is restricted. Therefore, as described above, at the mirror surface adjusting mechanism 28, due to the wheel drives 34 (including the meshing claws 34B) being rotated, the meshed positions of the distal ends of the meshing claws 34B with the screws 36A of the rod drives 36 are displaced, and the rod drives 36 are moved (slid) in the vehicle longitudinal direction (the axial direction).

Operation of the present embodiment is described next.

In the door mirror device 10 for a vehicle of the above-described structure, due to electrical operation of the mirror surface adjusting mechanism 28, the motors 30 are driven, and the worms 32 are rotated integrally with the output shafts 30B of the motors 30, and, due thereto, the wheel drives 34 are rotated, and the rod drives 36 are moved in the vehicle longitudinal direction. Therefore, the mirror body 38 (the mirror 40 and the mirror holder 42) is tilted by the rod drives 36 in at least one of the vertical direction or the vehicle transverse direction, and the angle of the mirror surface 40A of the mirror 40 (the direction of viewing by the vehicle occupant whom the mirror 40 assists) is thereby adjusted in at least one of the vertical direction or the vehicle transverse direction.

Here, the limiting plates 16E of the visor body 16 are inserted in the limiting holes 24C of the reinforcement 24 (the bottom wall portion 24A), and the engaging claws 46 (the convex portions 46A) of the limiting plates 16E are engaged with the limiting holes 24C. Due thereto, movement of the reinforcement 24 toward the vehicle front side with respect to the visor body 16 is limited, and the reinforcement 24 is held at the visor body 16. Therefore, before the reinforcement 24 is assembled to the visor body 16 by the fastening of the third screw 18C and the fourth screw 18D and the like, the limiting plates 16E are inserted in the limiting holes 24C, and the engaging claws 46 are engaged with the limiting holes 24C. Due thereto, the reinforcement 24 can be held (temporarily positioned) at the visor body 16, and the ability to assemble the reinforcement 24 to the visor body 16 can be improved.

Moreover, due to the engaging claws 46 being engaged with the limiting holes 24C, the engaging claws 46 urge the reinforcement 24 (the bottom wall portion 24A) in the extending direction (toward the vehicle rear side), and the force of holding the reinforcement 24 at the visor body 16 by the engaging claws 46 can be increased effectively. Therefore, before the reinforcement 24 is assembled to the visor body 16, due to the engaging claws 46 being engaged with the limiting holes 24C and the engaging claws 46 urging the reinforcement 24 in the extending direction, the force of holding the reinforcement 24 at the visor body 16 can be increased effectively, and the ability to assemble the reinforcement 24 to the visor body 16 can be improved effectively.

Further, the guide plates 44 (including the pairs of projecting portions 44A) of the limiting plates 16E fit-together with the limiting holes 24C in the length directions and the width directions, and movement of the reinforcement 24 in the peripheral direction and the radial direction of the bottom wall portion 24A is limited. Therefore, before the reinforcement 24 is assembled to the visor body 16, due to the guide plates 44 (including the pairs of projecting portions 44A) being fit-together with the limiting holes 24C in the length directions and the width directions, movement of the reinforcement 24 in the peripheral direction and the radial direction of the bottom wall portion 24A can be limited, and the ability to assemble the reinforcement 24 to the visor body 16 can be improved effectively.

Moreover, due to the engaging claws 46 being engaged with the limiting holes 24C, the engaging claws 46 urge the reinforcement 24 toward the radial direction outer side of the bottom wall portion 24A, and cause the pairs of projecting portions 44A of the guide plates 44 to press-contact the bottom wall portion 24A radial direction inner side surfaces of the limiting holes 24C. Therefore, before the reinforcement 24 is assembled to the visor body 16, the engaging claws 46 are engaged with the limiting holes 24C, and the pairs of projecting portions 44A of the guide plates 44 are made to press-contact the bottom wall portion 24A radial direction inner side surfaces of the limiting holes 24C. Due thereto, movement of the reinforcement 24 in the peripheral direction and the radial direction of the bottom wall portion 24A can be effectively limited, and the ability to assemble the reinforcement 24 to the visor body 16 can be improved effectively.

Further, at the time when the limiting plates 16E are inserted into the limiting holes 24C, the insertion of the guide plates 44 into the limiting holes 24C is started, and thereafter, the terminals 48A of the reinforcement 24 are inserted in the motors 30 (the proximal end portions of the main body portions 30A). Therefore, due to the guide plates 44 (including the pairs of projecting portions 44A) being inserted in the limiting holes 24C, insertion of the terminals 48A into the motors 30 can be guided, and the ability to insert the terminals 48A into the motors 30 can be improved.

Moreover, the limiting plate 16E and the limiting hole 24C that are at the vehicle transverse direction inner side and the lower side are disposed in a vicinity of the proximal end portions of the main body portions 30A of the pair of motors 30, and the limiting plate 16E and the limiting hole 24C that are at the vehicle transverse direction inner side and the upper side are disposed in a vicinity of the distal end portion of the main body portion 30A that is at the vehicle transverse direction inner side, and the limiting plate 16E and the limiting hole 24C that are at the vehicle transverse direction outer side and the lower side are disposed in a vicinity of the distal end portion of the main body portion 30A that is at the vehicle transverse direction outer side (see FIG. 5). Therefore, due to the guide plates 44 (including the pairs of projecting portions 44A) of these respective limiting plates 16E being inserted in these respective limiting holes 24C, tilting of the terminals 48A with respect to the vehicle longitudinal direction can be suppressed, the inserting of the terminals 48A into the motors 30 can be guided appropriately, and the ability to insert the terminals 48A into the motors 30 can be improved effectively.

Further, the engaging claws 46 are provided integrally with the guide plates 44. Therefore, due to the guide plates 44 (including the pairs of projecting portions 44A) being inserted into the limiting holes 24C, the engaging of the engaging claws 46 with the limiting holes 24C can be guided appropriately, and the engaging claws 46 can be easily engaged with the limiting holes 24C.

Moreover, due to the guide plates 44 (including the pairs of projecting portions 44A) being inserted into the limiting holes 24C, the limiting holes 24C are guided by the guide plates 44 (including the pairs of projecting portions 44A) in the length directions and the width directions (the peripheries of the engaging claws 46). Therefore, the inserting of the terminals 48A into the motors 30 and the engaging of the engaging claws 46 with the limiting holes 24C can be guided more appropriately, and the ability to insert the terminals 48A into the motors 30 can be improved more, and the engaging claws 46 can be engaged more easily with the limiting holes 24C.

Further, as described above, due to the engaging claws 46 (the convex portions 46A) being engaged with the limiting holes 24C, movement of the reinforcement 24 (the bottom wall portion 24A) toward the vehicle front side with respect to the visor body 16 is limited. Therefore, even if load is applied from the mirror surface adjusting mechanism 28 to the reinforcement 24 (e.g., rotational loads of the main body portions 30A around the output shafts 30B that are due to the reaction forces arising due to the motors 30 being driven (the reaction forces arising due to the output shafts 30B and the worms 32 rotating the wheel drives 34), and load that is applied from the mirror 40 via the rod drives 36 and the wheel drives 34 at the time when the rod drives 36 are moved), the engaging claws 46 can limit movement of the reinforcement 24 toward the vehicle front side due to this load, and the reinforcement 24 can support the mirror surface adjusting mechanism 28 well.

Moreover, as described above, the engaging claws 46 urge the reinforcement 24 in the extending direction (toward the vehicle rear side). Therefore, the engaging claws 46 can effectively limit movement of the reinforcement 24 toward the vehicle front side due to load applied from the mirror surface adjusting mechanism 28, and the reinforcement 24 can support the mirror surface adjusting mechanism 28 even better. Due thereto, the need to fasten the bottom wall portion 24A of the reinforcement 24 to the visor body 16 by screws can be eliminated.

Further, the engaging claw 46 and the limiting hole 24C that are at the vehicle transverse direction inner side and the lower side are disposed in a vicinity of the proximal end portions of the main body portions 30A of the pair of motors 30, and the engaging claw 46 and the limiting hole 24C that are at the vehicle transverse direction inner side and the upper side are disposed in a vicinity of the distal end portion of the main body portion 30A that is at the vehicle transverse direction inner side, and the engaging claw 46 and the limiting hole 24C that are at the vehicle transverse direction outer side and the lower side are disposed in a vicinity of the distal end portion of the main body portion 30A that is at the vehicle transverse direction outer side. The pair of main body portions 30A are disposed in region A that is surrounded by these respective engaging claws 46 (see FIG. 5). Therefore, these respective engaging claws 46 can effectively limit movement of the reinforcement 24 toward the vehicle front side, which is due to rotational loads of the main body portions 30A around the output shafts 30 at times when the motors 30 are driven, and the reinforcement 24 can effectively support the pair of main body portions 30A.

Moreover, the engaging claw 46 and the limiting hole 24C that are at the vehicle transverse direction outer side and the upper side are disposed in a vicinity of the pair of wheel drives 34, and the engaging claw 46 and the limiting hole 24C that are at the vehicle transverse direction inner side and the upper side are disposed in a vicinity of the wheel drive 34 that is at the upper side, and the engaging claw 46 and the limiting hole 24C that are at the vehicle transverse direction outer side and the lower side are disposed in a vicinity of the wheel drive 34 that is at the vehicle transverse direction outer side. The pair of wheel drives 34 (including central axes X of the pair of wheel drives 34) are disposed in region B that is surrounded by these respective engaging claws 46 (see FIG. 5). Therefore, these respective engaging claws 46 can effectively limit movement of the reinforcement 24 toward the vehicle front side, which is due to load that is applied from the mirror 40 via the rod drives 36 and the wheel drives 34 when the rod drives 36 move, and the reinforcement 24 can effectively support the pair of wheel drives 34. Due thereto, changes over time (e.g., deformation) of the visor body 16 (the covering wall 16C) and the reinforcement 24 (the bottom wall portion 24A), which are due to movement of the rod drives 36 being repeated, can be suppressed.

Note that, in the present embodiment, the limiting plates 16E are provided at the visor body 16. However, for example, the covering wall 16C, the connecting wall 16D and the limiting plates 16E may be made to be bodies that are separate from the visor body 16, and the limiting plates 16E may be made to be bodies that are separate from the visor body 16.

Moreover, in the present embodiment, the limiting plates 16E are provided at the visor body 16 side, and the limiting holes 24C are provided at the reinforcement 24 side. However, the limiting plates 16E may be provided at the reinforcement 24 side, and the limiting holes 24C may be provided at the visor body 16 side.

Further, in the present embodiment, the mirror body 38 is made to be the viewing mechanism. However, a camera, which assists viewing by the vehicle occupant by capturing images, may be made to be the viewing mechanism.

Moreover, in the present embodiment, the door mirror device 10 for a vehicle (the viewing device for a vehicle) is set at the outer side of a door of the vehicle. However, the viewing device for a vehicle may be set at another position of the vehicle.

The disclosure of Japanese Patent Application No. 2016-183429 that was filed on Sep. 20, 2016 is, in its entirety, incorporated by reference into the present specification.

### EXPLANATION OF REFERENCE NUMERALS

10 door mirror device for a vehicle (viewing device for a vehicle)
24 reinforcement (covering member)
28 mirror surface adjusting mechanism (operating mechanism)
38 mirror body (viewing mechanism)
44 guide plate (guiding portion)
46 engaging claw
48A terminal

1. A viewing device for a vehicle, the viewing device comprising:
a viewing mechanism that assists viewing by an occupant of a vehicle;
an operating mechanism that, by being operated, the viewing mechanism is tilted;
a covering member that covers the operating mechanism; and
an engaging claw that, by being engaged, the covering member is held.

2. The viewing device for a vehicle of claim 1, comprising:
a terminal that is provided at the covering member, that is connected to the operating mechanism, and that supplies electric power; and
a guiding portion at which the engaging claw is provided, and that guides connecting of the terminal to the operating mechanism.

3. The viewing device for a vehicle of claim 2, wherein the guiding portion guides the connecting of the terminal to the operating mechanism in a periphery of the engaging claw.

4. The viewing device for a vehicle of claim 2, wherein the engaging claw, by an urging force, causes the guiding portion and the covering member to contact one another.

5. The viewing device for a vehicle of claim 2, wherein, after connecting of the covering member and the guiding portion is started, the guiding portion guides the connecting of the terminal to the operating mechanism.

6. The viewing device for a vehicle of claim 1, wherein the engaging claw limits movement of the covering member, the movement being due to a load applied from the operating mechanism.

7. The viewing device for a vehicle of claim 6, comprising a driving mechanism that is provided at the operating mechanism and generates driving force that tilts the viewing mechanism, wherein the engaging claw limits movement of the covering member, the movement being due to a load applied from the driving mechanism.

8. The viewing device for a vehicle of claim 6, comprising a transmitting member that is provided at the operating mechanism and transmits driving force that tilts the viewing mechanism, wherein the engaging claw limits movement of the covering member, the movement being due to a load applied from the transmitting member.

9. The viewing device for a vehicle of claim 6, wherein a plurality of the engaging claws are provided at a periphery of a region of the covering member to which a load is applied from the viewing mechanism via the operating mechanism.

10. The viewing device for a vehicle of claim 1, wherein the engaging claw urges the covering member in an extending direction.

11. The viewing device for a vehicle of claim 1, comprising an accommodating body that accommodates the viewing mechanism, and to which the covering member is fixed, and that is reinforced by the covering member.
